(19) United States
(12) Patent Application Publication
(10) Pub. No.: US 2007/0126140 A1
(43) Pub. Date: Jun. 7, 2007

(54) METHOD OF PRODUCING A REINFORCED PLASTIC PROFILE

(76) Inventors: Klaus Jansen, Buxtehude (DE); Christian Gensewich, Bremervorde (DE)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/560,887

(22) Filed: Nov. 17, 2006

(30) Foreign Application Priority Data
Nov. 30, 2005 (DE) 102005 057487.4
Sep. 13, 2006 (DE) 102006042920.6

(51) Int. Cl. D02G 1/20; B29C 41/24; B29C 47/00

(52) U.S. Cl. 264/103; 264/165; 264/176.1

(57) ABSTRACT

A method of producing a reinforced plastic profile (10) with a uniform profile cross section, in which the transverse reinforcement (12) is formed by a linked, knitted, sewn or woven tube. Such a tube can be seamlessly formed continuously during the production of the plastic profile (10), which is preferably performed by pultrusion.

### STATEMENT OF RELATED APPLICATIONS

This patent application claims convention priority on and is based on German Patent Application No. 10 2005 057 487.4, having a filing date of 30 Nov. 2005, and German Patent Application No. 10 2006 042 920.6, having a filing date of 13 Sep. 2006, both of which are incorporated herein in their entireties by this reference.

### BACKGROUND OF THE INVENTION

1. Technical Field

The invention relates to a method of producing a reinforced plastic profile, at least one reinforcement being provided with plastic by drawing in a drawing direction.

2. Related Art

Plastic profiles are reinforced to improve the mechanical properties, in particular to improve their strength. In the simplest case, one reinforcement is provided for this purpose. If one reinforcement alone is not adequate, an additional transverse reinforcement is provided.

It is known to form reinforcements or transverse reinforcements from prefabricated nonwoven or woven fabrics. These prefabricated nonwoven or woven fabrics are laid together with an overlap at a seam. This causes a lack of symmetry, which is disadvantageous in particular in the case of rotationally symmetrical plastic profiles and those for which dimensional stability is important.

Furthermore, the incorporation of prefabricated woven and nonwoven fabrics can only be integrated in the production process of the plastic profile with great effort.

### BRIEF SUMMARY OF THE INVENTION

The invention is based on the object of providing a method of producing a reinforced plastic profile which allows simple formation of the reinforcement, in particular the transverse reinforcement, and great accuracy, particularly of rotationally symmetrical plastic profiles.

A method to achieve this object comprises a method of producing a reinforced plastic profile, at least one reinforcement being provided with plastic by drawing in a drawing direction, wherein the at least one reinforcement is formed entirely or partly from at least one row of stitches and/or loops of at least one yarn or thread and/or by weaving structures obtained. This envisages forming the reinforcement at least partly from at least one row of stitches and/or loops of at least one yarn or a thread. Alternatively or in addition, it is envisaged to form the reinforcement at least partly from structures that have been produced by weaving technologies. With preference, a transverse reinforcement surrounding a longitudinal reinforcement is produced in this way. The stitches, loops and/or structures form around the longitudinally running reinforcing strands of the longitudinal reinforcement a homogeneous transverse reinforcement, which gives the plastic profile good strength and good dimensional stability, in particular the plastic profile is provided with outstanding symmetry by virtue of the uniformity of the transverse reinforcement that can be achieved with stitches, structures or loops.

With preference, it is envisaged to create from the at least one row of stitches, loops, structures or the like a tube-like covering or encapsulation of the reinforcing strands. The tube-like covering forms in particular an especially uniform transverse reinforcement. The tube-like covering for forming the transverse reinforcement is arranged with preference tightly around the longitudinal reinforcement; it may, however, also loosely surround the longitudinal reinforcement or be provided as a single reinforcement.

In the case of a preferred method, it is envisaged to form the tube-like encapsulation or covering from a number of layers each of a row of stitches, structures and/or loops, the stitches, structures or loops being formed with preference from a yarn or thread of the material provided for the longitudinal reinforcement. In this way, a reinforcement, in particular transverse reinforcement, that satisfies the requirements can be formed, the multiple layers altogether forming a tube-like encapsulation that is approximately the same thickness all around, as a result of which rotationally symmetrical plastic profiles can be produced with great precision, in particular great roundness, even in the case of multilayer transverse reinforcements.

According to a preferred development of the method, it is envisaged to produce the tube-like encapsulation or covering for forming the reinforcement, in particular the transverse reinforcement, continuously as the longitudinally directed reinforcing strands are being further transported in the drawing direction. As a result, the formation of the reinforcement can be integrated as it were “in line” in the production process. This makes it possible to dispense with preceding production stages or intermediate stages, as are required in the case of the known prefabrication of woven and nonwoven fabrics to form reinforcements.

According to a further proposal of the invention, the tube-like covering for forming the reinforcement, in particular the transverse reinforcement, is produced using needles which can move back and forth. With preference, the stitches, structures and/or loops of each layer of the tube-like covering are produced by knitting, in particular circular knitting, sewing, linking or weaving. With the known methods, a particularly uniform tube-like covering can be produced, to be precise with yarns or threads of all suitable materials. In particular, the tube-like covering can be continuously produced by knitting, linking, sewing our weaving simply with needles which can move back and forth, to be precise at a drawing rate correspondingly the rate of production.

If, in particular, the transverse reinforcement is produced by sewing or weaving with warp and weft threads, the weft threads run in the longitudinal direction of the strands of the longitudinal reinforcement. In this case, at least some of the weft threads of the transverse reinforcement may be formed by some or all of the longitudinal strands of the longitudinal reinforcement. It is also possible to interweave, interlace or intertwine, at least partially, the longitudinal strands of the longitudinal reinforcement, in the form of weft threads, and the weft threads of the transverse reinforcement, also running in the longitudinal direction of the longitudinal strands. In the case of the previously described refinement of the invention, parts of the longitudinal reinforcement are formed by the transverse reinforcement, or vice versa. The longitudinal reinforcement and the transverse reinforcement are interconnected in this way to form a single reinforcement.

The threads or yarns for producing the tube-like covering of the reinforcement or transverse reinforcement are preferably formed from the material of the reinforcing strands of the longitudinal reinforcement running in the drawing direction. These may be yarns or threads of organic and inorganic fibers, that is to say both natural fibers and synthetic fibers, for example glass fibers or carbon fibers.

According to a preferred refinement of the invention, it is envisaged to draw the yarns or threads for producing the tube-like encapsulation or covering from reels or drums, these reels or drums preferably being assigned in an unchanging location to the apparatus serving for drawing the strands, to be precise at such a point that the yarns or threads for producing the tube-like covering are fed to the longitudinally running reinforcing strands and entangled, linked or interwoven with the encapsulation before the plastics material is applied to the reinforcing strands of the longitudinal reinforcement and the tube-like covering of the transverse reinforcement.

The method according to the invention is used with preference in the pultrusion of plastic profiles. In the case of this special drawing process, the invention can be integrated particularly advantageously in the production process, in that the stitched, linked or woven covering is produced “in line” in the pultrusion.

### BRIEF DESCRIPTION OF THE DRAWINGS

Preferred exemplary embodiments of the invention are explained in more detail below on the basis of the drawing, in which:

FIG. 1 shows a simplified perspective representation of a pultrusion apparatus.

FIG. 2 shows a plan view of apparatus for producing a transverse reinforcement.

FIG. 3 shows a sectional representation of part of a plastic profile produced by the method according to the invention, with the only schematically (symbolically) represented transverse reinforcement.

FIG. 4 shows a perspective representation of part of a woven transverse reinforcement.

### DETAILED DESCRIPTION OF PREFERRED EMBODIMENTS

The invention concerns the production of an extruded plastic profile 10. The exemplary embodiment shown relates to the production of the plastic profile 10 by pultrusion. The invention may, however, also be used in connection with other strand-drawing processes for producing the plastic profile 10.

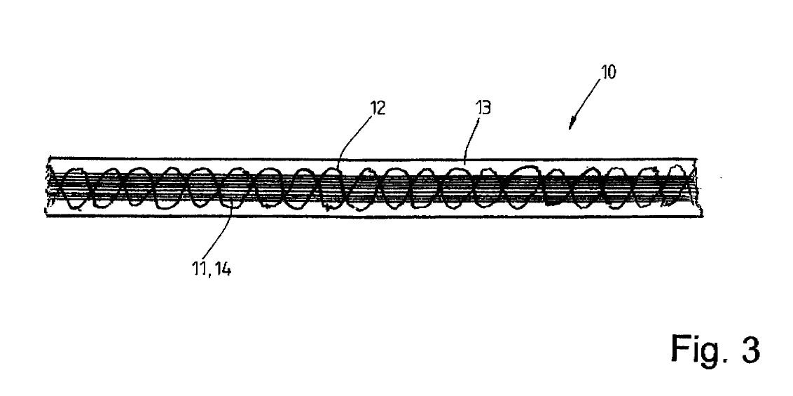

The plastic profile 10 shown in FIG. 3 has an approximately oval cross section. In the case of the method according to the invention, however, plastic profiles of any other desired cross sections, both rotationally symmetrical cross sections and asymmetrical cross sections, including those with undercuts, may also be produced.

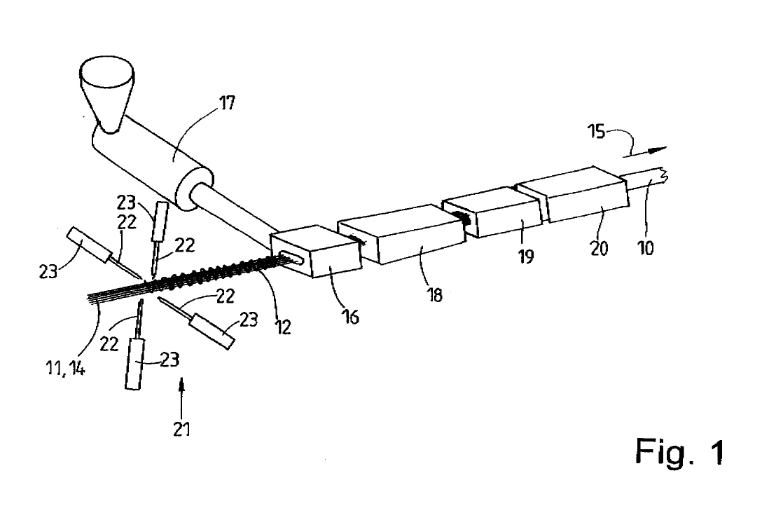

The plastic profile 10 shown has a longitudinal reinforcement 11 and a transverse reinforcement 12. In FIGS. 1 and 3, the transverse reinforcement is represented only in a simplified form, that is say is only indicated. Both the longitudinal reinforcement 11 and the transverse reinforcement 12 are impregnated at least partially, preferably completely, with plastic and completely surrounded by the plastic, which is preferably a thermosetting material 13. The single- or multilayer transverse reinforcement 12 surrounds the longitudinal reinforcement 11 in a tube-like manner, the transverse reinforcement 12 preferably tightly surrounding the longitudinal reinforcement 11.

The longitudinal reinforcement 11 is formed by individual reinforcing strands 14 running continuously in the longitudinal direction of the plastic profile 10. Reinforcing strands 14 may, if appropriate, also be interlaced, spun or connected in some other way. The transverse reinforcement 12 is formed by fibers or yarns, which surround the longitudinal reinforcement 11 in a tube-like manner in at least one row of stitches and/or loops running in the longitudinal direction of the transverse profile 10. It is conceivable to form the transverse reinforcement 12 from a number of threads or yarns, the tube-like transverse reinforcement 12 then preferably being formed from a number of layers each of a row of stitches or loops or combinations of stitches and/or loops. In addition or as an alternative, the transverse reinforcement 12 may also be formed from structures which have been obtained for example by weaving technologies.

It is also possible to provide an only partial transverse reinforcement, in regions of the plastic profile that are particularly subjected to loading. Such partial transverse reinforcements surround the longitudinal reinforcement 11 only partially, that is to say they do not form a closed tube-like covering of the longitudinal reinforcement 11.

The yarns or threads of the transverse reinforcement 12 are formed with preference from the same material as the strands of the longitudinal reinforcement 11. These are strands of a natural material, for example hemp or flax, or else a synthetic material, for example glass or carbon fibers. Similarly, the fibers and yarns of the transverse reinforcement 12 may be formed from hemp, flax or other natural materials, but also from synthetic fibers, for example carbon or glass fibers. It is also conceivable to form the strands from fibers of different materials, and similarly the yarns and threads. The yarns and threads may also be formed from different materials than the strands of the longitudinal reinforcement 11. With regard to the materials of the longitudinal reinforcement 11 and of the transverse reinforcement 12, there are no limits in the case of the method according to the invention.

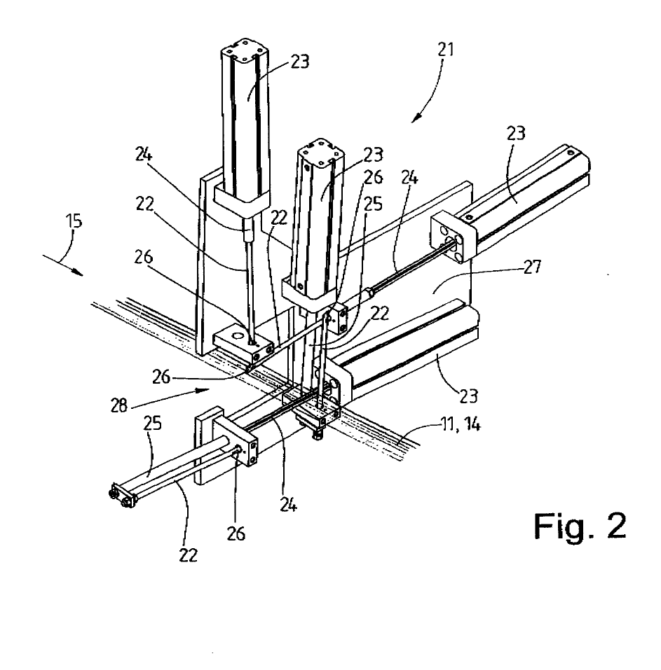

The pultrusion apparatus shown in FIG. 2 has, seen in the direction of pultrusion 15, an impregnating mold 16, which is laterally assigned an extruder 17, a then following impregnating zone 18, arranged behind that a mold 19 and finally a cooling zone 20 at the end. Upstream of the impregnating mold 16 there is an apparatus for producing the transverse reinforcement 12, surrounding the longitudinal reinforcement 11 in a tube-like manner. In the exemplary embodiment shown, this apparatus is a linking apparatus 21. In place of the linking apparatus 21, a knitting apparatus, in particular a circular knitting apparatus, a sewing apparatus or a weaving apparatus may also be arranged upstream of the impregnating mold 16. The individual connected or unconnected strands of the longitudinal reinforcement 11 run continuously through the linking apparatus 21 and the subsequent pultrusion apparatus, that is to say the impregnating mold 16, the impregnating zone 18, the mold 19 and the cooling zone 20. The seamless, tube-like covering for forming the transverse reinforcement 12 is produced around the longitudinal reinforcement 11 by the linking apparatus 21, before the longitudinal reinforcement 11 and the transverse enforcement 12 are impregnated with plastic. Accordingly, the longitudinal reinforcement 11 and the transverse reinforcement 12, arranged preferably tightly around it, run together in the direction of pultrusion 15 through the impregnating mold 16, where polymer plasticated by the extruder 17 is fed in, and subsequently through the impregnating zone 18, the mold 19 and the cooling zone 20.

The linking apparatus 21 arranged upstream of the impregnating mold 16 provides the longitudinal reinforcement 11 continuously with the transverse reinforcement 12, for which purpose the operating speed of the linking apparatus 21 corresponds to the rate at which the longitudinal reinforcement 11 and the transverse reinforcement 12 provided around it are drawn through the pultrusion apparatus in the direction of pultrusion 15.

The linking apparatus 21 shown in FIGS. 2 and 3 serves for producing the transverse reinforcement 12 from a number of layers. The linking apparatus 21 has four needles 22, which in each case provide a yarn or a thread with an elongated row of stitches or loops running in the direction of pultrusion 15. However, the invention can also be realized with a greater or smaller number of needles 22. In the exemplary embodiment shown, all the needles 22 are arranged obliquely in relation to the direction of pultrusion 15, such that a needle 22 is located on each side next to the longitudinal reinforcement 11. The straight needles 22 can be moved up and down or back and forth on a straight path. In this case, all the needles 22 move laterally past the longitudinal reinforcement 11, without touching it. The four needles 22 arranged around the longitudinal reinforcement 11 lie in a plane which intersects the direction of pultrusion 15, that is to say the direction of the longitudinal reinforcement 11, perpendicularly or at an oblique angle. It is also conceivable, however, if need be to orient the needles 22 differently, in order to produce transverse reinforcements 12 with some other pattern of stitches or loops.

Each of the needles 22, all of a straight form, is assigned a pressure medium cylinder 23, which is preferably a pneumatic cylinder. The straight needles 22 can be moved by the pressure medium cylinder 23 transversely in relation to the direction of pultrusion 15 on a path running straight in the longitudinal direction of said needles, to be precise from one side of the bundle of strands of the longitudinal reinforcement 11 to the opposite side.

In the case of the linking apparatus 21 shown in FIG. 3, which is arranged upstream of the impregnating mold 16 of the pultrusion apparatus, all the pressure medium cylinders 23 are arranged on one side of the longitudinal reinforcement 11. Since the needles 22 move in pairs from opposite sides of the longitudinal reinforcement 11, from one side of the longitudinal reinforcement 11 to the other, two needles 22 directed the other way round are arranged at one end of a distance sleeve 25 extending a piston rod 24 of the pressure medium cylinder 23 concerned. The tips 26 of these two needles 22 thereby point toward the pressure medium cylinder 23, while the tips 26 of the two other needles are directed away from the pressure medium cylinders 23, extending the piston rods 24 of the pressure medium cylinder 23 concerned. If all four pressure medium cylinders 23 are extended, the two needles 22 move from one side and two needles 22 move from the other side over or under the longitudinal reinforcement 11.

All four pressure medium cylinders 23 with the needles 22 are mounted on a common planar support plate 27. The support plate 27 has a laterally open cutout 28. The longitudinal strands of the longitudinal reinforcement 11 transported further in the direction of pultrusion 15 run through this cutout 28. The linking apparatus 21 shown in FIG. 3 is assigned to the direction of pultrusion 15 in such a way that the plane of the support plate 27 intersects the direction of pultrusion 15, and consequently the longitudinal reinforcement 11, perpendicularly, the longitudinal reinforcement 11 running through the cutout 28 in the support plate 27 in the direction of pultrusion 15.

The method according to the invention proceeds as follows:

Before the actual pultrusion operation takes place, that is to say before the reinforcement is impregnated and/or encapsulated with preferably thermosetting material, the transverse reinforcement 12 is produced continuously from at least one row of structures, stitches or loops around the strands of the longitudinal reinforcement 11 running in the direction of pultrusion 15. For this purpose, the strands of the longitudinal reinforcement 11 are provided with the seamless tube-shaped covering for forming the transverse reinforcement 12 by the linking apparatus 21 upstream of the impregnating mold 16 of the pultrusion apparatus. In the exemplary embodiment shown, the tube-shaped covering is formed from a number of threads or yarns, namely four threads or yarns, by linking. This involves creating the uniform tube-shaped covering of the transverse reinforcement 12 surrounding the longitudinal reinforcement 11, which transverse reinforcement comprises four layers in the exemplary embodiment shown with the linking apparatus 21 having four needles 22. The transverse reinforcement 12 surrounds the longitudinal reinforcement 11 from the outside, surrounding it tightly. In the exemplary embodiment shown, the stitches or loops run transversely in relation to the longitudinal direction of the strands of the longitudinal reinforcement 11.

The strands of the longitudinal reinforcement 11 are continuously linked in a looping formation, to be precise at a rate of advancement which corresponds to the rate of pultrusion. In other words, the linking takes place at the same rate at which the strands of the longitudinal reinforcement 11 are drawn through the pultrusion apparatus in the direction of pultrusion 15.

The strands of the longitudinal reinforcement 11 surrounded on the outside by the seamless tube-like transverse reinforcement 12 are continuously moved together at the same rate through the impregnating mold 16 in the direction of pultrusion 15. In the impregnating mold 16, liquid polymer produced by the extruder 17 is fed to the longitudinal reinforcement 11 and the transverse reinforcement 12 surrounding the latter. This causes the encapsulation, and also at least partial impregnation, of the strands or fibers or yarns of the longitudinal reinforcement 11 and of the transverse reinforcement 12. Following the impregnating mold 16, the longitudinal reinforcement 11 and transverse reinforcement 12 provided with plastic are moved further in the direction of pultrusion 15 through the impregnating zone 18, the then following mold 19, in which the plastic profile 10 is given its final outer shape, and finally through the cooling zone 20. At the end of the cooling zone 20, the finished plastic profile 10 leaves the pultrusion apparatus as a continuous strand. Plastic profiles 10 of appropriate length are cut off from this strand by means of a cutting-to-length apparatus.

In the case of the method according to the invention, the transverse reinforcement 12, that is to say the tube-like covering of the longitudinal reinforcement 11, may also be produced by knitting, in particular circular knitting, sewing or weaving. In this case, as in the case of linking, the tube-shaped or only partial transverse reinforcement 12 may also comprise a number of layers by using a corresponding number of needles.

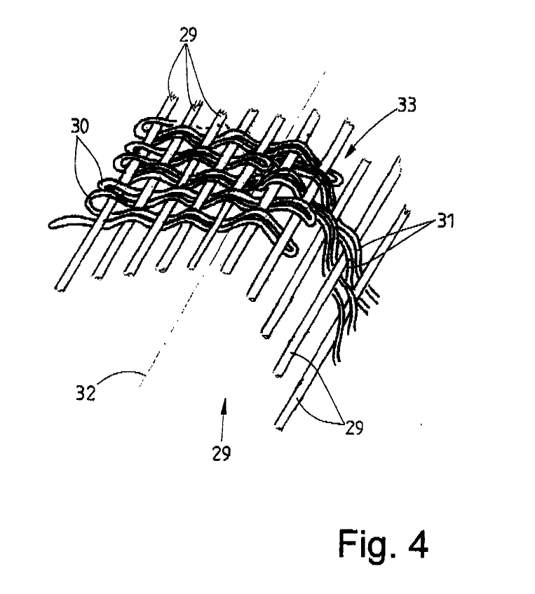

FIG. 4 perspectively shows part of a woven transverse reinforcement 29. The woven transverse reinforcement 29 has warp threads 30 and weft threads 31. The warp threads 30 run parallel to one another along the direction of pultrusion 32. Accordingly, the weft threads 31 run transversely in relation to the direction of pultrusion 32. The warp threads 30 may be some or all of the longitudinal strands of the longitudinal reinforcement (not shown in the figure), which is at least partially enclosed by the transverse reinforcement 29. It is also conceivable to interlace, intertwine or interweave the warp threads 30 of the transverse reinforcement 29 with the longitudinal strands of the longitudinal reinforcement running parallel to the warp threads 30.

The partly shown transverse reinforcement 29 has warp threads 30 in an approximately horizontal plane and weft threads 30 in an approximately vertical plane. The weft threads 31 meet in the corner between the horizontal and vertical warp threads 30. To form a corner connection of the weft threads 31, the warp thread 30 of the corner is used jointly and alternately by the continuous weft threads 31. This involves weaving in a looping formation the weft thread 30 forming a corner, which leads to a corner connection 33 of the transverse reinforcement 29.

The woven transverse reinforcement 29 partly shown in FIG. 4 is produced in the way described above as it were “in line” in the production of the profile, to be precise at the rate of pultrusion of the plastic profile. The warp threads and the weft threads 31 are drawn from supply reels which are assigned in a stationary manner, that is to say at a fixed location, to the pultrusion apparatus. The supply reels are only freely rotatable about stationary axes of rotation, for drawing off the warp threads 30 and the weft threads 31.

The exemplary embodiments of the invention described above are formed on a plastic profile with at least one longitudinal reinforcement 11 and at least one transverse reinforcement 12 or 29 entirely or partially surrounding the latter. However, it is also conceivable to provide the plastic profile only with one reinforcement, which however is preferably formed as a transverse reinforcement 12 or 29, so that the longitudinal reinforcement 11 is absent. The single reinforcement is then formed in a way according to the invention by knitting, in particular circular knitting, sewing, linking or weaving, and has at least one row of structures, stitches and/or loops of at least one yarn or thread.

### LIST OF DESIGNATIONS

10 plastic profile
11 longitudinal reinforcement
12 transverse reinforcement
13 polymer
14 reinforcing strand
15 direction of pultrusion
16 impregnating mold
17 extruder
18 impregnating zone
19 mold
20 cooling zone
21 linking apparatus
22 needle
23 pressure medium cylinder
24 piston rod
25 distance sleeve
26 tip
27 support plate
28 cutout
29 transverse reinforcement
30 warp thread
31 weft thread
32 direction of pultrusion
33 corner connection

What is claimed is:

1. A method of producing a reinforced plastic profile (10), at least one reinforcement being provided with plastic by drawing in a drawing direction, wherein the at least one reinforcement is formed entirely or partly from at least one row of stitches and/or loops of at least one yarn or thread and/or by weaving structures obtained.

2. The method as claimed in claim 1, wherein a tube-like covering for forming the reinforcement is created by the at least one row of stitches, loops and/or structures.

3. The method as claimed in claim 1, wherein the tube-like covering is formed from a number of layers of rows of stitches, structures and/or loops.

4. The method as claimed in claim 2, wherein the tube-like covering is produced continuously during the production of the plastic profile (10).

5. The method as claimed in claim 4, wherein the tube-like covering is produced continuously during the formation of the plastic profile as the reinforcement (11) is being further transported in the drawing direction.

6. The method as claimed in claim 1, wherein the yarns or threads for producing the textile-like covering forming the reinforcement (12) are drawn from reels or drums, preferably fixed-location drums or reels.

7. The method as claimed in claim 2, wherein the tube-like covering for forming a reinforcement is produced by knitting, in particular circular knitting, linking or weaving.

8. The method as claimed in claim 2, wherein the tube-like covering for forming the reinforcement is produced by needles (22) which can move back and forth.

9. The method as claimed in claim 8, wherein the reinforcement comprises a number of layers, each layer of the tube-like covering forming the reinforcement being produced by at least one needle (22) which can move on a straight path.

10. The method as claimed in claim 1, wherein the reinforcement is formed by at least one longitudinal reinforcement (11) and at least one transverse reinforcement (12).

11. The method as claimed in claim 8, wherein at least one needle (22) is moved on a straight path which deviates in direction from the drawing direction and intersects the path of the at least one longitudinal reinforcement (11), without colliding with the at least one longitudinal reinforcement (11).

12. The method as claimed in claim 8, wherein the at least one needle (22) extends next to the at least one longitudinal reinforcement.

13. The method as claimed in claim 10, wherein the yarns or threads for forming at least the transverse reinforcement (12) are drawn from reels assigned at a fixed location to the needles (22).

14. The method as claimed in claim 10, wherein at least one transverse reinforcement (12) surrounds the at least one longitudinal reinforcement (11).

15. The method as claimed in claim 10, wherein the threads or yarns for producing the transverse reinforcement (12) formed as a tube-like covering of the longitudinal reinforcement (11) are formed from the material of the longitudinal reinforcement (11).

16. The method as claimed in claim 10, wherein the transverse reinforcement (12) is produced tightly around the longitudinal reinforcement (11).

17. The method as claimed in claim 1, wherein the drawing of the plastic profile (10) is performed by pultrusion.

18. The method as claimed in claim 2, wherein the tube-like covering is formed from a number of layers of rows of stitches, structures and/or loops.
